(19) United States
(12) Patent Application Publication
(10) Pub. No.: US 2025/0350821 A1
(43) Pub. Date: Nov. 13, 2025

(54) Camera Sensor with Shared Pixel Weighting

(71) Applicant: Wisconsin Alumni Research Foundation, Madison, WI (US)

(72) Inventors: Zihan Yin, Madison, WI (US); Akhilesh Jaiswal, Madison, WI (US)

(21) Appl. No.: 18/658,147

(22) Filed: May 8, 2024

(51) Int. Cl. H04N 23/52; G06N 3/0464; H04N 23/80

(52) U.S. Cl. CPC H04N 23/52; G06N 3/0464; H04N 23/80

(57) ABSTRACT

A camera sensor architecture provides in-pixel processing using weights that may be generated remotely from the pixels and applied to the pixels using a network switch for rapid in-pixel convolution useful as a first stage in a neural network.

### STATEMENT REGARDING FEDERALLY SPONSORED RESEARCH OR DEVELOPMENT

### CROSS REFERENCE TO RELATED APPLICATION

### BACKGROUND OF THE INVENTION

The present invention relates generally to camera sensors and in particular to a camera sensor allowing for the flexible application of different weighting values to the camera pixels, for example, to provide a convolution layer in a neural network.

Video acquisition and interpretation applications, such as autonomous driving, surveillance, object detection, object tracking, and anomaly detection, make use of camera sensors, such as CMOS image sensors (CIS), processed by deep learning algorithms. Such systems can be energy inefficient and experience throughput bottlenecks in the transmission of high volumes of data between the sensors and the deep learning processor, the latter of which may be, for example, in the cloud.

Energy-efficient computing solutions exist in the form of near-sensor, in-sensor, and in-pixel processing, bringing the computation closer to the sensor. In-pixel processing embeds computation capabilities inside the pixel array and achieves higher energy efficiency by generating low-level features instead of the raw data stream from CMOS image sensors. Different in-pixel processing techniques and approaches have been demonstrated on conventional frame-based CMOS imagers; however, current designs can require excessive amounts of circuit area, require unusual circuit elements that are difficult to fabricate, or lack the necessary configurability.

### SUMMARY OF THE INVENTION

The present invention provides an in-pixel processing system that employs weighting elements flexibly interconnected to different pixels by a switch network allowing both a sharing of weighting values among pixels, to reduce total circuit area, and the ability to locate the weighting circuitry away from the light-sensitive pixel regions for improved pixel density.

In one embodiment, the invention provides an image sensor having an array of light sensing elements arranged in logical rows and columns each providing an electrical sensor output indicating a pixel value of an image. A set of multipliers associated with each light sensor receive each electrical sensor output and a weight value to provide a weighted pixel output. A weight generator having multiple weight elements produces different weight values which are connected by a switching network to different light sensing elements to share weight values with the multipliers of different light sensing elements.

It is thus a feature of at least one embodiment of the invention to permit a sharing of weight circuitry among pixels to greatly reduce the necessary area for in-pixel processing.

The weight generator may be positioned outside a boundary holding multiple light sensing elements, for example, integrated in a two-dimensional 2.5 dimensional or three-dimensional manner.

It is thus a feature of at least one embodiment of the invention to permit the weight generating circuitry to be moved outside of the light sensitive area for improved light sensor design in terms of sensitivity, pixel-pitch, resolution, and integrated circuit area necessary for interconnections.

The light sensors of each column may share a shared weight value on a single conductor connected to the switching network.

It is thus a feature of at least one embodiment of the invention to greatly reduce the weight control wiring in the area of the light sensors as would be required for local weighting circuitry.

The image sensor may include a stride controller selectively activating the switching network to shift the different weight values together along the columns according to a predetermined stride amount without changing the different weight values.

It is thus a feature of at least one embodiment of the invention to permit a ready reconfiguration of convolution stride without changing the underlying hardware or architecture. The switching provides substantially faster convolution striding than can be provided by changing the weight values.

The light sensors of each column may share a common output conductor for their different weight values and each column may include a summing junction attached to the common output conductor for summing the different weight values.

It is thus a feature of at least one embodiment of the invention to minimize interconnections needed for convolution summing that might use valuable circuit area.

The light sensors of a column may receive individual row activation signals to switch the corresponding weighted pixel outputs to a common conductor so that the summing junction adds together weighted pixel outputs only for activated light sensors.

It is thus a feature of at least one embodiment of the invention to provide in-pixel processing that can implement a convolution operation.

The image sensor may further include convolution neural network receiving the summed weighted pixel outputs as outputs of a first convolution layer of a convolution neural network.

It is thus a feature of at least one embodiment of the invention to provide in-pixel processing for a first or first several layers of a convolution neural network used, for example, for image processing.

Each weight element may provide a set of fixed or variable current sources switchably connected in parallel to provide different weight values. For example, the current sources may be transistors with different conductive areas determining a contribution of the transistor to the different weight value.

It is thus a feature of at least one embodiment of the invention to provide a ratiometrically precise and stable weight generator.

In another embodiment, the weight elements may provide continuously variable and programmable weight values. Examples of such elements include a non-volatile memory (NVM) device selected from the group consisting of a magnetic tunnel junction (MTJ) device, a phase change memory (PCM) device, an FeFET transistor, and CTT transistor, a FLASH transistor and a memrister.

It is thus a feature of at least one embodiment of the invention to make use of sophisticated semiconductor devices to simplify and reduce the area of the weight elements.

These particular objects and advantages may apply to only some embodiments falling within the claims and thus do not define the scope of the invention.

### BRIEF DESCRIPTION OF THE DRAWINGS

FIG. 1 is a block diagram of a camera system providing a pixel array with in-pixel processing to provide a convolution layer for subsequent convolution on a neural network, the latter producing a desired output;

FIG. 2 is a block diagram of a first embodiment of the invention showing, in fragment, a column of pixels joined by a switch network with a set of fixed weight blocks and showing common output lines for summing pixel outputs as weighted;

FIG. 3 is a detailed schematic of one weight block of FIG. 2 implemented with different transistors switched in combination to provide different weights;

FIG. 4 is a fragmentary view of one pixel element of FIG. 2; and

FIG. 5 is a schematic representation of the switch network of FIG. 2.

### DETAILED DESCRIPTION OF THE PREFERRED EMBODIMENT

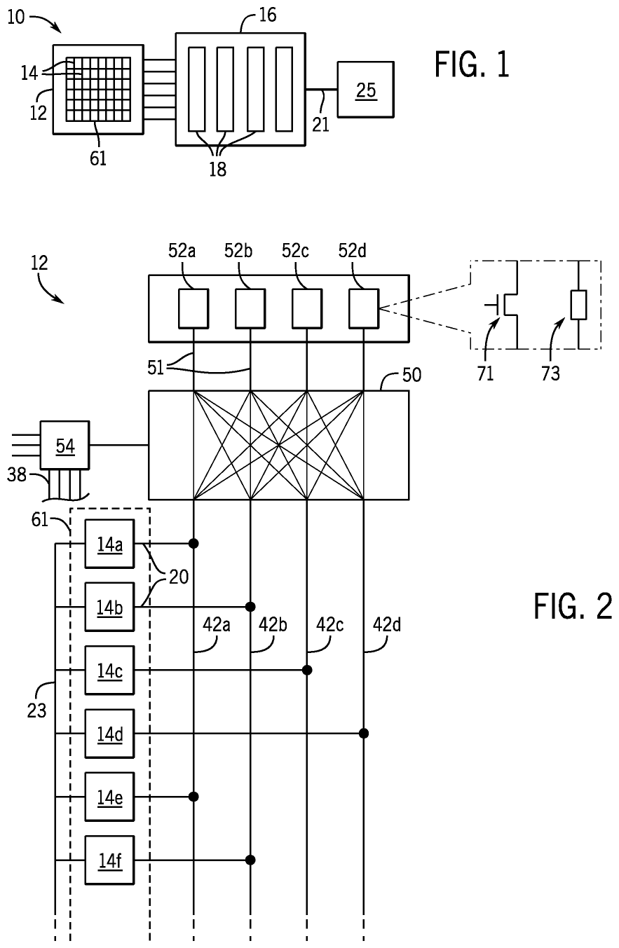

Referring now to FIG. 1, a camera system 10 may provide a sensor array 12 constructed according to the present invention having multiple pixel elements 14 arrayed in logical rows and columns, being not necessarily in geometrically rectilinear rows and columns. Outputs of the sensor array 12 may implement a first convolution layer or for several convolution layers of a neural network whose output is received by neural network 16 providing processing additional layers 18. In combination the sensor array 12 and the neural network 16 provide a processed image output 21 for use, for example, controlling autonomous vehicle 25 or other applications by identifying imaged objects.

Referring now to FIG. 2, the in-pixel sensor array 12 may provide a set of pixels each receiving a weight value 20 and providing a weighted pixel output 22 being a function of the weight value 20 and received illumination 24.

Referring now momentarily to FIG. 4, in one embodiment the pixel element 14 may provide a photodiode 26 sensitive to received camera illumination 24. The photodiode 26 may be charged by a biasing transistor 28, the latter receiving a reset signal 30 for that charging and discharges depleted by the received illumination 24 over time. The voltage on the cathode of the photodiode 26 is received at the gate of a transistor 32 which also receives a weight value 20 (to be described below) to produce a weighted pixel output 22. The weighted pixel output 22 is selectively connected to a summing junction line 23 by gating transistor 34, the latter controlled by a row read line 38.

A detailed description of various aspects of a pixel element 14 suitable for use with the present invention is described in MAA Kaiser, G Datta, S Sarkar, S Kundu, Z Yin, M Garg, A P Jacob, Technology-Circuit-Algorithm Tri-Design for Processing-in-Pixel-in-Memory (P2M) arXiv preprint arXiv:2304.02968, hereby incorporated by reference.

Generally the weighted pixel outputs 22 of multiple pixel elements 14, represented by current values, are summed together at the summing junction line 23 and processed by an analog-to-digital converter assembly 44 which may also provide for a compression to implement a ReLu layer of the neural network.

Referring again to FIG. 2, the weight values 20 for each pixel element 14 in a column are provided by different shared weight conductors 42a-42d, being four in this example but generally being of arbitrary number and typically between two and five or two and seven. For a number of weight conductors 42 equal to N, every Nth pixel element 14 in a column will connect to the same weight conductor 42. The number N of shared weight conductors 42a-42d is set equal to a desired maximum stride of a convolution processing kernel.

Each of the common shared weight conductors 42a-42d are connected to output terminals of an N×N switch network 50. Input terminals of the switch network 50,equal in number to the output terminals, receive weight values 51 from blocks 52a-52d according to a switch signal from a stride controller 54 which also controls the row read lines connecting rows of pixel elements to control their activation. Generally the weight blocks 52 may provide individual or banks of transistors 71 providing a variable current or resistance depending on a dynamically received control signal or programmable solid-state device 73, such as a non-volatile memory (NVM) device selected from the group consisting of a magnetic tunnel junction (MTJ) device, a phase change memory (PCM) device, and a memrister. In some embodiments fixed weight values may be employed.

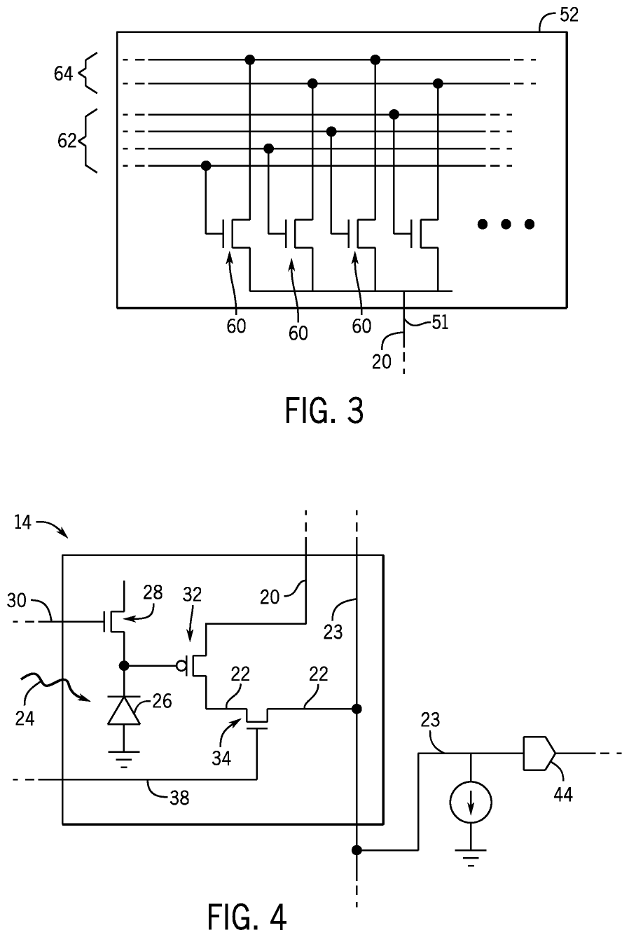

Referring now to FIG. 3, in one embodiment, each of the weight blocks 52 may provide multiple transistors 60 connected in parallel so that their conducted currents, when the transistors are turned on, sum together. Each of the multiple transistors 60 may be fabricated to produce a different on-state current representing a different weight, for example, by controlling transistor area or other transistor parameters. In addition, these transistors 60 may have different bias voltages 64 allowing both negative and positive weight values 51 to be generated. In some embodiments, multiple transistors can be activated at once, for example, having binary weights to provide a range of weight values 51.

These different weights may be applied to any of the shared weight conductors 42a-42d by proper switching of the switch network 50 to provide a flexibly defined weight kernel that may be convoluted over the array 12. Generally, the structure of FIG. 2 is duplicated for each column of pixels in that array with common connections to the stride controller 54.

The stride controller 54 may control a convolution kernel height and position in a column by selectively activating row read lines 38 for a set of rows defining the kernel height and position and by controlling the switch network 50 to apply the desired weights to the activated rows of a column. As the kernel is moved vertically the weights may stay the same but need to be switched by the switch network 50 during that movement when the stride length is different from the maximum anticipated stride N. The switch network 50 thus allows a variety of different stride lengths to be adopted without time-consuming changing of the weight values 51.

By sharing the values from the weight blocks 52 with multiple pixel elements 14 the integrated circuit area necessary for the weight blocks 52 can also be substantially reduced by eliminating the need to reproduce the weight blocks 52 for each pixel element 14. Further, the weight blocks 52 may be moved outside of a boundary 61 holding the pixel elements 14 to free this area up for light-sensitive structure.

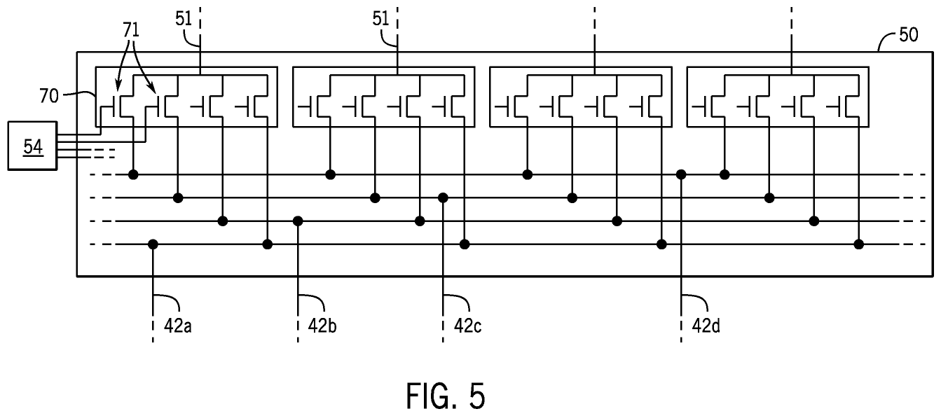

Referring now to FIG. 5, in one embodiment the switch network 50 provides multiple N banks 70 of N switchable transistors 71 connected in parallel to one weight value 51 of one weight block 52, with each transistor 71 of a bank 70 providing a conductive path to a different one of N shared weight conductors 42.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What we claim is:

1. An image sensor comprising:
an array of light sensing elements arranged in logical rows and columns each providing an electrical sensor output indicating a pixel value of an image;
a set of multipliers associated with each light sensor receiving the electrical sensor output and a weight value to provide a weighted pixel output;
a weight generator having multiple weight elements outputting different weight values; and
a switching network connecting individual weight elements selectively to different light sensing elements to share weight values with the multipliers of light sensing elements.

2. The image sensor of claim 1 wherein the weight generator is displaced from area between the multiple light sensing elements.

3. The image sensor of claim 1 wherein the light sensing elements of each column share a shared weight value on a single conductor connected to the switching network.

4. The image sensor of claim 3 further including a stride controller selectively activating the switching network to apply the different weight values at a predetermined stride periodicity along a column without changing the different weight values.

5. The image sensor of claim 4 wherein the stride controller provides an input for receiving a stride input controlling the predetermined stride amount.

6. The image sensor of claim 5 wherein the stride controller operates to control the predetermined stride amount from between 2 and 5.

7. The image sensor of claim 1 wherein the light sensing elements of each column share a common output conductor for their different weight values, the column including a summing junction attached to the common output conductor for summing the different weight values.

8. The image sensor of claim 7 wherein the light sensing elements of a column receive individual row activation signals to switch the corresponding weighted pixel outputs to a common conductor so that the summing junction adds together weighted pixel outputs only for activated light sensing elements.

9. The image sensor of claim 3 further including a neural network receiving the summed weighted pixel outputs as outputs of a first convolution layer of a convolution neural network.

10. The image sensor of claim 1 wherein each weight element comprises a set of fixed current sources switchably connected in parallel to provide different weight values.

11. The image sensor of claim 10 wherein the fixed current sources are transistors with different conductive areas determining a contribution of the transistor to the different weight values.

12. The image sensor of claim 1 wherein the switching network is a crossbar switch selectively connecting each input to any of each output according to a connection signal.

13. The image sensor of claim 12 wherein the crossbar switch provides a number of inputs and outputs within the range of 2 to 7.

14. The image sensor of claim 1 wherein the weight elements provide continuously variable and programmable weights.

15. The image sensor of claim 14 wherein the weight elements are non-volatile memory (NVM) devices selected from the group consisting of a of a magnetic tunnel junction (MTJ) device, a phase change memory (PCM) device, an FeFET transistor, and CTT transistor, a FLASH transistor and a memrister.
